(19) United States
(12) Patent Application Publication
(10) Pub. No.: US 2026/0322464 A1
(43) Pub. Date: Oct. 15, 2026

(54) USER EQUIPMENT (UE) ANTENNA SELECTION BASED ON MULTI-TRANSMISSION RECEPTION POINT (TRP) FEEDBACK

(71) Applicant: QUALCOMM Incorporated, San Diego, CA (US)

(72) Inventors: Vasanthan RAGHAVAN, West Windsor Township, NJ (US); Tao LUO, San Diego, CA (US)

(21) Appl. No.: 19/641,937

(22) Filed: Apr. 8, 2026

Related U.S. Application Data
(60) Provisional application No. 63/788,443, filed on Apr. 14, 2025.

(51) Int. Cl. H04B 7/06; H04B 7/08

(52) U.S. Cl. CPC H04B 7/0691; H04B 7/0608; H04B 7/0802

(57) ABSTRACT

This disclosure provides methods, components, devices and systems for selecting user equipment (UE) antennas. For example, a UE may transmit, via multiple antennas of the UE, a set of reference signals in accordance with configuration information received from a first transmit reception point (TRP), a second TRP, or both. Additionally, the UE may receive, from each of the first TRP and the second TRP, respective feedback information for the multiple antennas. Thus, the UE may select, based on the feedback information, a first subset of antennas (e.g., of the multiple antennas) for communicating one or more first messages with the first TRP and a second subset of an antennas (e.g., of the multiple antennas) for communicating one or more second messages with the second TRP.

### CROSS REFERENCES

This patent application claims the benefit of U.S. Provisional Patent Application No. 63/788,443 by RAGHAVAN et al., entitled “USER EQUIPMENT (UE) ANTENNA SELECTION BASED ON MULTI-TRANSMISSION RECEPTION POINT (TRP) FEEDBACK,” filed Apr. 14, 2025, assigned to the assignee hereof, and expressly incorporated herein.

### TECHNICAL FIELD

This disclosure relates generally to wireless communication, and more specifically to systems, devices, methods, and techniques associated with user equipment (UE) antenna selection based on multi-transmission reception point (TRP) feedback.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving configuration information for a set of reference signals to be measured by a plurality of network entities, the plurality of network entities comprising at least a first network entity and a second network entity, transmitting, via a plurality of antennas of the UE, the set of reference signals in accordance with the configuration information, receiving, from each of the first network entity and the second network entity, feedback information for the plurality of antennas, communicating one or more first messages with the first network entity via a first subset of antennas of the plurality of antennas, wherein the first subset of antennas is selected based at least in part on the feedback information, and communicating one or more second messages with the second network entity via a second subset of antennas of the plurality of antennas, wherein the second subset of antennas is selected based at least in part on the feedback information.

A UE for wireless communications is described. The UE may include a processing system that comprises processor circuitry and memory circuitry that stores code. The processing system may be configured to cause the UE to receive configuration information for a set of reference signals to be measured by a plurality of network entities, the plurality of network entities comprising at least a first network entity and a second network entity, transmit, via a plurality of antennas of the UE, the set of reference signals in accordance with the configuration information, receive, from each of the first network entity and the second network entity, feedback information for the plurality of antennas, communicate one or more first messages with the first network entity via a first subset of antennas of the plurality of antennas, wherein the first subset of antennas is selected based at least in part on the feedback information, and communicate one or more second messages with the second network entity via a second subset of antennas of the plurality of antennas, wherein the second subset of antennas is selected based at least in part on the feedback information.

Another UE for wireless communications is described. The UE may include means for receiving configuration information for a set of reference signals to be measured by a plurality of network entities, the plurality of network entities comprising at least a first network entity and a second network entity, means for transmitting, via a plurality of antennas of the UE, the set of reference signals in accordance with the configuration information, means for receiving, from each of the first network entity and the second network entity, feedback information for the plurality of antennas, means for communicating one or more first messages with the first network entity via a first subset of antennas of the plurality of antennas, wherein the first subset of antennas is selected based at least in part on the feedback information, and means for communicating one or more second messages with the second network entity via a second subset of antennas of the plurality of antennas, wherein the second subset of antennas is selected based at least in part on the feedback information.

A non-transitory computer-readable medium storing code for wireless communications is described. The code may include instructions executable by one or more processors to receive configuration information for a set of reference signals to be measured by a plurality of network entities, the plurality of network entities comprising at least a first network entity and a second network entity, transmit, via a plurality of antennas of the UE, the set of reference signals in accordance with the configuration information, receive, from each of the first network entity and the second network entity, feedback information for the plurality of antennas, communicate one or more first messages with the first network entity via a first subset of antennas of the plurality of antennas, wherein the first subset of antennas is selected based at least in part on the feedback information, and communicate one or more second messages with the second network entity via a second subset of antennas of the plurality of antennas, wherein the second subset of antennas is selected based at least in part on the feedback information.

In some examples of the method, UEs, and non-transitory computer-readable medium described herein, the set of reference signals include a first subset of reference signals to be measured by the first network entity and a second subset of reference signals to be measured by the second network entity, wherein the first subset of reference signals may be different from the second subset of reference signals.

In some examples of the method, UEs, and non-transitory computer-readable medium described herein, receiving configuration information for the set of reference signals may include operations, features, means, or instructions for receiving, from the first network entity, a first control message indicating first configuration information for the first subset of reference signals and receiving, from the second network entity, a second control message indicating second configuration information for the second subset of reference signals.

In some examples of the method, UEs, and non-transitory computer-readable medium described herein, transmitting the set of reference signals may include operations, features, means, or instructions for transmitting the first subset of reference signals via the plurality of antennas of the UE and transmitting the second subset of reference signals via the plurality of antennas of the UE.

In some examples of the method, UEs, and non-transitory computer-readable medium described herein, transmitting the set of reference signals may include operations, features, means, or instructions for transmitting each reference signal of the first subset of reference signals via a respective antenna of the plurality of antennas and transmitting each reference signal of the second subset of reference signals via a respective antenna of the plurality of antennas.

In some examples of the method, UEs, and non-transitory computer-readable medium described herein, the set of reference signals include a shared set of reference signals to be measured by each network entity of the plurality of network entities.

In some examples of the method, UEs, and non-transitory computer-readable medium described herein, the configuration information may be received from one network entity of the plurality of network entities based at least in part on the shared set of reference signals being measured by each network entity of the plurality of network entities.

In some examples of the method, UEs, and non-transitory computer-readable medium described herein, each reference signal of the shared set of reference signals may be transmitted via a respective antenna of the plurality of antennas.

In some examples of the method, UEs, and non-transitory computer-readable medium described herein, the feedback information comprises one or more channel quality indicators (CQIs), one or more modulation and coding schemes (MCSs), one or more uplink signal-to-noise ratios (SNRs), one or more uplink signal strength estimates, one or more uplink channel vector estimates, or any combination thereof.

In some examples of the method, UEs, and non-transitory computer-readable medium described herein, receiving the feedback information may include operations, features, means, or instructions for receiving, from the first network entity, first feedback information for the plurality of antennas and receiving, from the second network entity, second feedback information for the plurality of antennas.

Some examples of the method, UEs, and non-transitory computer-readable medium described herein may further include operations, features, means, or instructions for transmitting, to the first network entity, an indication of the first subset of antennas based at least in part on selection of the first subset of antennas for the first network entity, wherein communication of the one or more first messages may be based at least in part on transmission of the indication.

### BRIEF DESCRIPTION OF THE DRAWINGS

FIG. 1 shows an example of a wireless communication system.

FIG. 2 shows an example of a signaling diagram that supports user equipment (UE) antenna selection based on multi-transmission reception point (multi-TRP) feedback.

FIG. 3 shows examples of resource configurations that support UE antenna selection based on multi-TRP feedback.

FIG. 4 shows an example of a process flow that supports UE antenna selection based on multi-TRP feedback.

FIG. 5 shows a block diagram of a processing system that supports UE antenna selection based on multi-TRP feedback.

FIG. 6 shows a diagram of a system including a device that supports UE antenna selection based on multi-TRP feedback.

FIG. 7 shows a flowchart illustrating methods that support UE antenna selection based on multi-TRP feedback.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a UE may communicate via multiple antennas and, in some cases, may select a subset of the multiple antennas to communicate with a transmission reception point (TRP). In such cases, to select the subset of the multiple antennas, the UE may perform measurements via each antenna of the multiple antennas. However, as a quantity of the multiple antennas of the UE increase (e.g., 6 or 8 antennas in a frequency range 1 (FR1) or a frequency range 3 (FR3) and more than 8 in a frequency range 2 (FR2)), so does the power consumption associated with performing the measurements. Additionally, or alternatively, when the UE supports dual connectivity with multiple TRPs, the UE may perform the measurements via each antenna of the multiple antennas for each TRP of the multiple TRPs, further increasing power consumption of the UE and a complexity of antenna selection.

Aspects of the subject matter described in this disclosure relate to techniques for a UE to select, for each TRP of multiple TRPs, a respective subset of multiple antennas of the UE based on feedback information from the multiple TRPs. For example, the UE may support a first communication link with a first TRP and a second communication link with a second TRP. The UE may receive, from the first TRP, the second TRP, or both, configuration information for a set of reference signals, such as a set of sounding reference signals (SRSs). In some cases, the UE may receive, from the first TRP, a first configuration information for one or more first reference signals to be measured by the first TRP (e.g., from the first set of reference signals) and may receive, from the second TRP, a second configuration information for one or more second reference signals to be measured by the second TRP (e.g., from the first set of reference signals). Additionally, or alternatively, the UE may receive, from one of the first TRP or the second TRP, configuration information for the set of reference signals, where the set of reference signals are to be measured by both the first TRP and the second TRP. In such cases, the set of reference signals may be referred to as a shared set of reference signals.

In response, the UE may transmit, via the multiple antennas, the set of reference signals (e.g., the one or more first reference signals and the one or more second reference signals or the shared set of reference signals). Additionally, each TRP may measure at least a respective subset of the set of reference signals and may transmit, to the UE, respective feedback information for the multiple antennas (e.g., based on at least the respective subset of the set of reference signals). For example, the first TRP may transmit a first report indicating first feedback information for the multiple antennas based on the first set of reference signals (e.g., or the shared set of reference signals) and the second TRP may transmit a second report indicating second feedback information for the multiple antennas based on the second set of reference signals (e.g., or the shared set of reference signals). Thus, the UE may select, for each TRP, a respective subset of the multiple antennas based on the feedback information. For example, the UE may select a first subset of the multiple antennas to communicate one or more first messages to the first TRP and may select a second subset of the multiple antennas to communicate one or more second messages to the second TRP.

Particular aspects of the subject matter described in this disclosure can be implemented to realize one or more of the following potential advantages. In some examples, by receiving feedback information for the multiple antennas from each TRP, the described techniques may enable the UE to perform antenna selection for each TRP without performing measurements (e.g., by performing limited measurements) at the UE, which may reduce power consumption and complexity at the UE. Additionally, or alternatively, by selecting a respective subset of antennas for each TRP based on feedback information from each TRP, communications between the UE and each TRP may be associated with a lower error rate and a higher throughput.

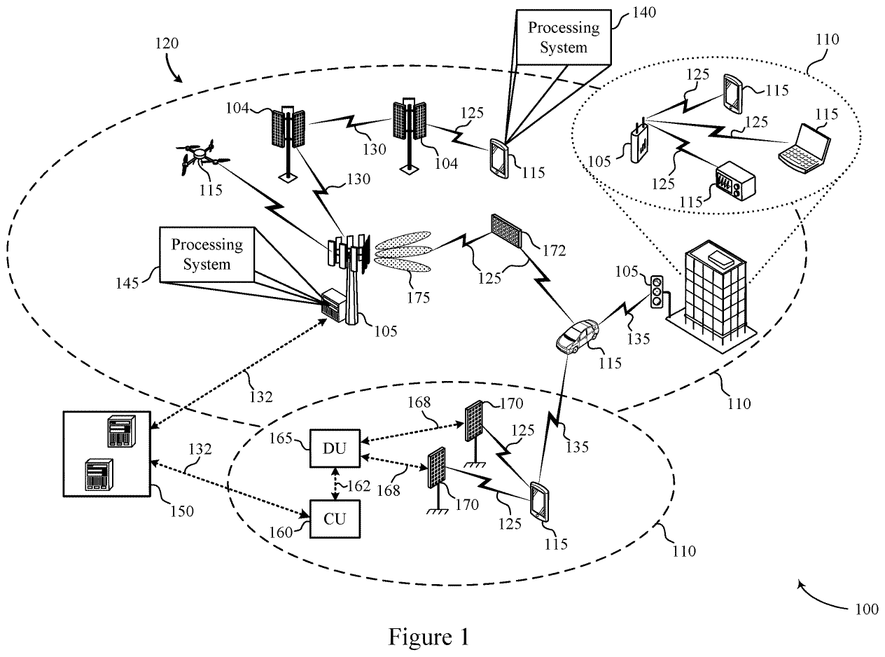

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for UE antenna selection based on multi-TRP feedback. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques to enable a UE to receive feedback information for multiple antennas of the UE from each TRP of a set of TRPs, which may further enable the UE to perform antenna selection for each TRP without performing measurements (e.g., by performing limited measurements) at the UE, which may reduce power consumption and complexity at the UE.

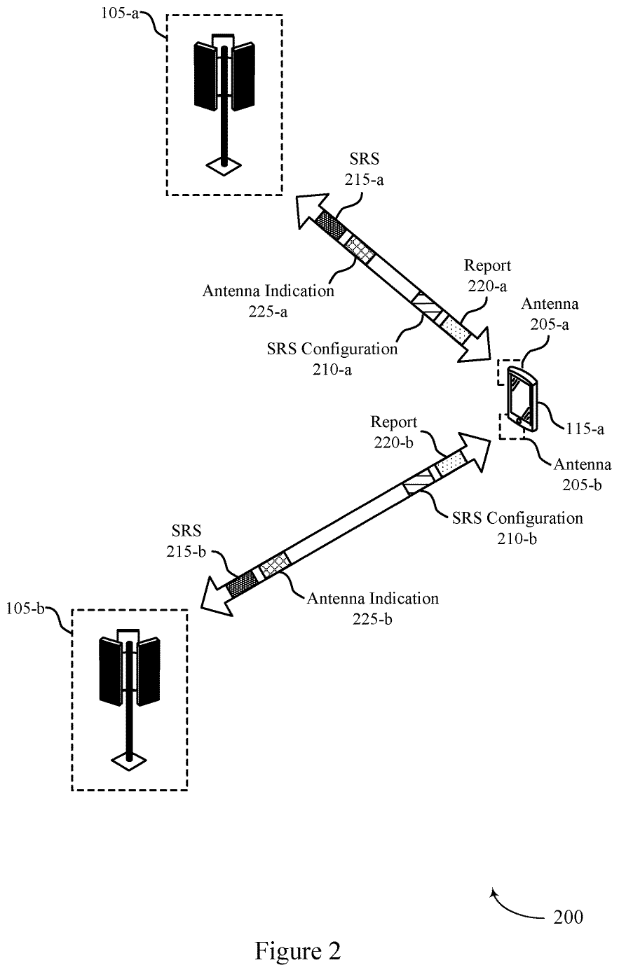

FIG. 2 shows an example of a signaling diagram 200 that supports UE antenna selection based on multi-TRP feedback. In some cases, the signaling diagram 200 may implement or be implemented by aspects of the wireless communication system 100. For example, the signaling diagram 200 may include one or more UEs 115 (e.g., a UE 115-a) and one or more network entities 105 (e.g., a network entity 105-a and a network entity 105-b), which may be examples of the corresponding devices as described herein.

In some wireless communications systems (e.g., in many UE implementations), a UE 115, such as the UE 115-a, may support multiple antennas 205 (e.g., N antennas), such as an antenna 205-a and an antenna 205-b. For example, in FR1 or FR3, the UE 115-a may support 6 or 8 antennas. Similarly, in FR2, the UE 115 may support even more than 8 antennas. In some cases, the UE 115-a communicating via all of the multiple antennas 205 may result in increased power consumption (e.g., unnecessary power consumption when the UE 115-a is capable of communicating via a subset of the multiple antennas 205). Additionally, or alternatively, during a reference signal occasion, the UE 115-a may perform one or more measurements (e.g., of a respective reference signal) using each antennas 205 to be used by the UE 115-a, however, a quantity of the multiple antennas 205 may exceed a quantity of measurements that the UE 115-a is capable of performing during the reference signal occasion, such that the UE 115-a is incapable of performing measurements for all of the multiple antennas 205 during the reference signal occasion (e.g., the UE 115-a may support more antennas 205 than independent measurements that can be performed over each reference signal occasion). Thus, the UE 115-a may select a subset of the multiple antennas 205 (e.g., antenna elements) to reduce power consumption at the UE 115-a. For example, the UE 115-a may support N antennas 205 and may select K antennas 205 to communicate with.

In some cases, the UE 115-a may select the subset of the multiple antennas 205 based on a recommendation from a network entity 105. For example, the network entity 105 may perform uplink measurements and may transmit, to the UE 115-a, a recommended antenna selection (e.g., as an antenna selection solution). However, in such cases, the network entity 105 may not be aware of one or more conditions at the UE 115-a (e.g., capabilities of the UE 115-a, a power level of the UE 115-a, a configuration of the UE 115-a, or any combination thereof), such that the recommended antenna selection may not consider the one or more conditions. Additionally, or alternatively, the UE 115-a may select the subset of the multiple antennas 205 based on one or more measurements by the UE 115-a via each antenna 205 of the multiple antennas 205. However, as a quantity of the multiple antennas 205 of the UE 115-a increase, so does the power consumption associated with performing the measurements. Additionally, or alternatively, when the UE 115-a supports dual connectivity with multiple network entities 105 (e.g., TRPs), the UE 115-a may perform the measurements via each antenna 205 of the multiple antennas 205 for each network entity 105 of the multiple network entities 105, further increasing power consumption of the UE 115-a and a complexity of antenna selection.

Accordingly, techniques described herein may enable the UE 115-a to select a respective subset of antennas 205 (e.g., of the multiple antennas 205) for each network entity 105, of a set of network entities 105, based on feedback information from each network entity 105 of the set of network entities 105. For example, as discussed herein, the UE 115-a may support multiple antennas 205, such as the antenna 205-a and the antenna 205-b (e.g., multiple discrete antennas 205 are available at FR1 and FR3 frequencies). Additionally, in some cases, the UE 115-a may communicate with multiple network entities 105 (e.g., at a same instance, simultaneously, via a single frequency network (SFN)), such as a network entity 105-a (e.g., first TRP) and a network entity 105-b (e.g., a second TRP), such that the multiple antennas 205 may be used to connect to (e.g., communicate with) the multiple network entities 105.

For example, the UE 115-a may support N antennas 205 and, at any given time, K antennas 205 (e.g., of the N antennas) may be selected by the UE 115-a (e.g., for communicating). Of the K antennas 205, K₁ antennas 205 (e.g., including the antenna 205-a) may be connected to (e.g., used to communicate with) the network entity 105-a and K₂ antennas 205 (e.g., including the antenna 205-b) may be connected to the network entity 105-b, where the UE 115-a selects the K₁ antennas 205 for the network entity 105-a and the K₂ antennas 205 for the network entity 105-b based on feedback from the network entity 105-a, the network entity 105-b, or both.

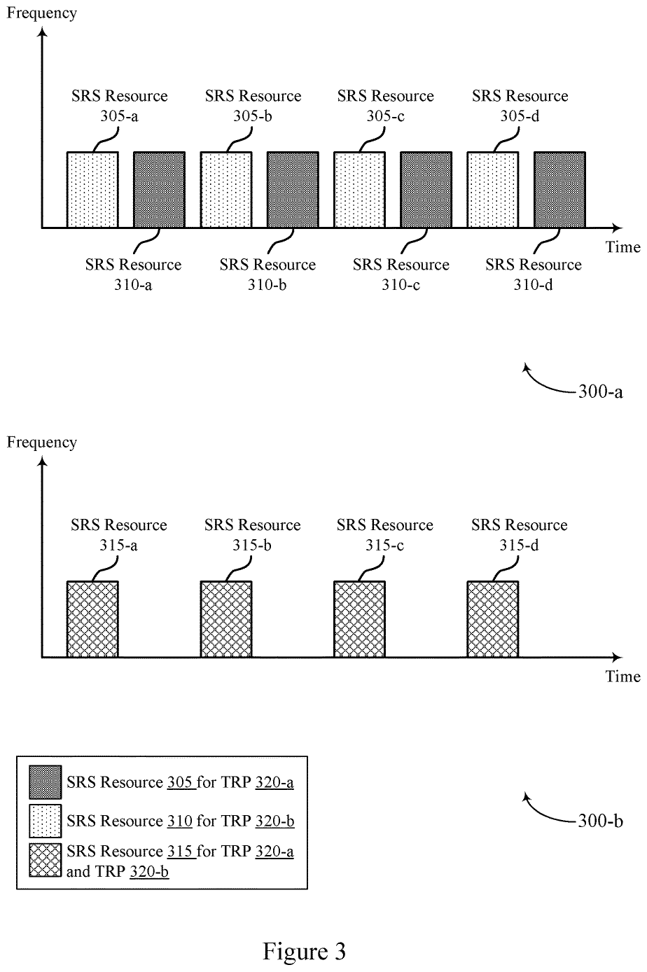

For example, the UE 115-a may receive, from the network entity 105-a, the network entity 105-b, or both, one or more reference signal configurations, such as SRS configurations 210, for one or more sets of reference signals, such as one or more sets of SRS 215. In some cases, as described with reference to a reference signal configuration 300-a depicted in FIG. 3, the network entities 105 may configure separate sets of SRSs 215 for each network entity 105-a. For example, as depicted in FIG. 2, the UE 115-a may receive, from the network entity 105-a, an SRS configuration 210-a for one or more SRS 215-a to be measured by the network entity 105-a and may receive, from the network entity 105-b, an SRS configuration 210-b for one or more SRSs 215-b to be measured by the network entity 105-b. Additionally, or alternatively, as described with reference to a reference signal configuration 300-b depicted in FIG. 3, the UE 115-a may receive, from one or the network entity 105-a or the network entity 105-b (e.g., or both), a single SRS configuration for a shared set of SRSs to be measured by both the network entity 105-a and the network entity 105-b (e.g., the SRS 215-a may be the same as the SRSs 215-b). In either case (e.g., separate sets of SRS 215 or a shared set of SRSs 215), the network entity 105-a and the network entity 105-b may communicate one or more control messages (e.g., via a backhaul communication link) to coordinate configuration of the one or more sets of SRSs 215 (e.g., the respective sets of SRSs 215, configuration of the shared set of SRSs 215, or both).

Thus, the UE 115-a may transmit, via the multiple antennas 205 (e.g., the N antennas 205 or the K antennas 205), the one or more sets of SRSs 215. Additionally, each of the network entities 105 may perform uplink measurements with at least a subset of the one or more sets of SRSs 215 (e.g., the respective sets of SRSs 215, configuration of the shared set of SRSs 215, or both) and provide feedback to the UE 115-a based on the uplink measurements. For example, in the case of separate sets of SRSs 215, the network entity 105-a may measure (e.g., perform uplink measurements with) the set of SRSs 215-a and may transmit, to the UE 115-a, a report 220-a indicating first feedback (e.g., feedback information) for the multiple antennas 205 based on measurement of the set of SRSs 215-a. Similarly, the network entity 105-b may measure the set of SRSs 215-b and may transmit, to the UE 115-a, a report 220-b indicating second feedback for the multiple antennas 205 based on measurement of the set of SRSs 215-b. In the case of the shared set of SRSs 215, each of the network entity 105-a and the network entity 105-b may measure the shared set of SRSs 215, such that the first feedback indicated via the report 220-a may be based on measurement of the shared set of SRSs 215 by the network entity 105-a and the second feedback indicated via the report 220-b may be based on measurement of the shared set of SRSs 215 by the network entity 105-b.

In some cases, the feedback may be channel state information (CSI) feedback. For example, each of the first feedback and the second feedback may indicate (e.g., include) one or more channel quality indicators (CQIs) associated with (e.g., corresponding to) one or more modulation and coding schemes (MCSs). For example, the respective feedback may indicate a CQI, an MCS, or both, for each antenna 205 of the multiple antennas 205. In such cases, the UE 115-a may determine a signal-to-noise ratio (SNR) based on each CQI, each MCS, or both, in accordance with a table (e.g., CQI/MCS table), where the table defines correlations between CQIs and respective SNRs, correlations between MCSs and respective SNRs, or both. In some cases, the table may be specific to a type of RAT. For example, a common table may be defined for downlink in 5G and 6G. In some other cases, the table may be different for downlink in 5G and 6G (e.g., the table can be specific to 6G). In some examples, the table may be based on reference signal data, one or more control channels, or both, transmitted by the UE 115-a. Additionally, or alternatively, each of the first feedback and the second feedback may indicate (e.g., include) one or more uplink SNRs, one or more uplink channel vector estimates, one or more uplink signal strength estimates, or any combination thereof (e.g., per antenna 205 of the multiple antennas 205). In some cases, reporting the one or more CQIs, the one or more MCSs, or both, may be associated with less overhead than reporting of the one or more uplink SNRs, the one or more uplink channel vector estimates, the one or more uplink signal strength estimates, or any combination thereof.

Based on the feedback from each network entity 105-a, the UE 115-a may determine (e.g., select, identify) a first subset of the multiple antennas 205 (e.g., K₁ antennas 205) to be used for the network entity 105-a and a second subset of the multiple antennas 205 (e.g., K₂ antennas 205) to be used for the network entity 105-b. In some cases, the UE 115-a may transmit an antenna indication 225 to each network entity 105 indicating a respective subset of the multiple antennas 205. For example, the UE 115-a may transmit, to the network entity 105-a, an antenna indication 225-a indicating that the first subset of the multiple antennas 205 (e.g., first port) are to be used for the network entity 105-a (e.g., indicating the first subset of the multiple antennas 205). Similarly, the UE 115-a may transmit, to the network entity 105-b, an antenna indication 225-b indicating that the second subset of the multiple antennas 205 (e.g., second port) are to be used for the network entity 105-b (e.g., indicating the second subset of the multiple antennas 205). In some examples, the respective subset of the multiple antennas 205 (e.g., ports) selected for each network entity 105 may be used for multi-TRP (mTRP) communications as well as single-TRP (sTRP) communications. For example, the UE 115-a may communicate (e.g., transmit or receive) one or more first messages with the network entity 105-a using the first subset of the multiple antennas 205 regardless of whether the UE 115-a is simultaneously communicating one or more second messages with the network entity 105-b using the second subset of the multiple antennas 205.

Though described in the context of SRS 215, this is not to be regarded as a limitation of the present disclosure. In this regard, any type of uplink signal may be transmitted by the UE 115-a for measurement by each network entity 105-a, including, but not limited to, one or more other types of reference signals. Additionally, or alternatively, though described in the context of two network entities 105, is not to be regarded as a limitation of the present disclosure. In this regard, the UE 115-a may communicate with any quantity of network entities 105, such that the UE 115-a selects a respective subset of the multiple antennas 205 for each network entity 105 of the quantity of network entities 105 based on feedback from each network entity 105 of the quantity of network entities 105.

FIG. 3 shows examples of reference signal configurations 300 (e.g., the reference signal configuration 300-a and the reference signal configuration 300-b) that support UE antenna selection based on multi-TRP feedback. In some cases, reference signal configurations 300 may be implemented by aspects of the wireless communication system 100, the signaling diagram 200, or both. For example, the reference signal configurations 300 may be implemented by one or more UEs 115 and one or more network entities 105, which may be examples of the corresponding devices as described herein.

As described with reference to FIG. 2, multiple TRPs 320 (e.g., network entities 105) may provide (e.g., configure) separate (e.g., uncoordinated) sets of SRS resources (e.g., opportunities) to a UE 115 for uplink transmissions (e.g., of SRS) or may provide a shared (e.g., coordinated, common) set of SRS resources to the UE 115 for the uplink transmissions. For example, according to the reference signal configuration 300-a, two TRPs, 320, including a TRP 320-a (e.g., TRP₁) and a TRP 320-b (e.g., TRP₂), may configure separate sets of SRS resources for measurement by respective TRPs 320 (e.g., configure SRS resources individually). For example, the TRP 320-a may transmit, to the UE 115, a first SRS configuration indicating an SRS resource 305-a

$$( e . g . , {SRS}_{1}^{1} ) ,$$

an SRS resource 305-b

$$( e . g . , {SRS}_{2}^{1} ) ,$$

an SRS resource 305-c

$$( e . g . , {SRS}_{3}^{1} ) ,$$

and an SRS resource 305-d

$$( e . g . , {SRS}_{4}^{1} )$$

to be used by the UE 115 to transmit a first set of SRSs for measurement by the TRP 320-a. Similarly, the TRP 320-b may transmit, to the UE 115, a second SRS configuration indicating an SRS resource 310-a

$$( e . g . , {SRS}_{1}^{2} ) ,$$

and an SRS resource 310-d

$$( e . g . , {SRS}_{2}^{2} ) ,$$

an SRS resource 310-c

$$( e . g . , {SRS}_{3}^{2} ) ,$$

and an SRS resource 310-d

$$( e . g . , {SRS}_{4}^{2} )$$

to be used by the UE 115 to transmit a second set of SRSs for measurement by the TRP 320-a. For example, in the example depicted in FIG. 3, each TRP 320 may configure 4 SRS resources individually for the UE 115

$$( e . g . , denoted as SR {S}_{j}^{i} , where i = 1 … 4 and j = 1 , 2 ) .$$

In such cases, the UE 115 may transmit the first set of SRSs via the SRS resources 305 for measurement by the TRP 320-a and may transmit the second set of SRSs via the SRS resources 310 for measurement by the TRP 320-b.

Additionally, or alternatively, according to the reference signal configuration 300-b, the TRPs 320 may configure (e.g., and coordinate use of) a single set of SRSs resources 315 for measurement by both TRPs 320 (e.g., jointly configure the SRS resources 315). For example, the TRP 320-a, the TRP 320-b, or both, may transmit, to the UE 115, a shared (e.g., single, one) SRS configuration indicating an SRS resource 315-a

$$( e . g . , {SRS}_{1}^{1 , 2} ) ,$$

an SKS resource 315-b

$$( e . g . , {SRS}_{2}^{1 , 2} ) ,$$

an SKS resource 315-c

$$( e . g . , SR {S}_{3}^{1 , 2} ) ,$$

and an SRS resource 315-d

$$( e . g . , {SRS}_{4}^{1 , 2} )$$

to be used by the UE 115 to transmit a shared set of SRSs for measurement by both TRPs 320. For example, in the example depicted in FIG. 3, both TRPs 320 may coordinate the use of 4 SRS resources for the UE 115

$$( e . g . , denoted as {SRS}_{j}^{i , k} , where j = 1 … 4 , i , k = 1 or 2 ) .$$

In such cases, the UE 115 may transmit the shared set of SRSs via the SRS resources 315 for measurement by both the TRP 320-a and the TRP 320-b (e.g., simultaneously). In either case (e.g., separate SRS resource configuration or joint SRS resource configuration), the SRS resources (e.g., opportunities) may be configured for TDD systems, FDD systems, or both.

In some cases, a quantity of SRS resources configured individually, by each TRP 320, or jointly may be based on a quantity of antennas of the UE 115. For example, the UE 115 may support N antennas, such that each TRP 320 may separately configure N SRS resources individually (e.g., N SRS resources 305 and N SRS resources 310) or both TRPs may jointly configure N SRS resources (e.g., N SRS resources 315). In either case e.g., separate or joint configuration), each SRS resource (e.g., each SRS resource 305, each SRS resource 310, each SRS resource 315) may correspond to an antenna of the N antennas, such that each antenna (e.g., of the N antennas) is used to transmit an SRS via a corresponding SRS resource.

In some other examples, the UE 115 may support N antennas and K antennas of the N antennas may be selected by the UE 115 (e.g., may be active, may be on), such that each TRP 320 may separately configure K SRS resources individually (e.g., K SRS resources 305 and K SRS resources 310) or both TRPs may jointly configure K SRS resources (e.g., K SRS resources 315). In either case (e.g., separate or joint configuration), each SRS resource (e.g., each SRS resource 305, each SRS resource 310, each SRS resource 315) may correspond to an antenna of the K antennas, such that each antenna (e.g., of the K antennas) is used to transmit an SRS via a corresponding SRS resource.

Though described in the context of SRS, this is not to be regarded as a limitation of the present disclosure. In this regard, any type of uplink signal may be transmitted by the UE 115 for measurement by each TRP 320 including, but not limited to, one or more other types of reference signals. Additionally, or alternatively, though described in the context of two TRPs 320, is not to be regarded as a limitation of the present disclosure. In this regard, the UE 115 may communicate with any quantity of TRPs 320, such that each TRP 320 of the quantity of TRPs 320 separately configures a respective set of SRS resources or all TRPs 320 of the quantity of TRPs 320 jointly configure a shared set of SRS resources.

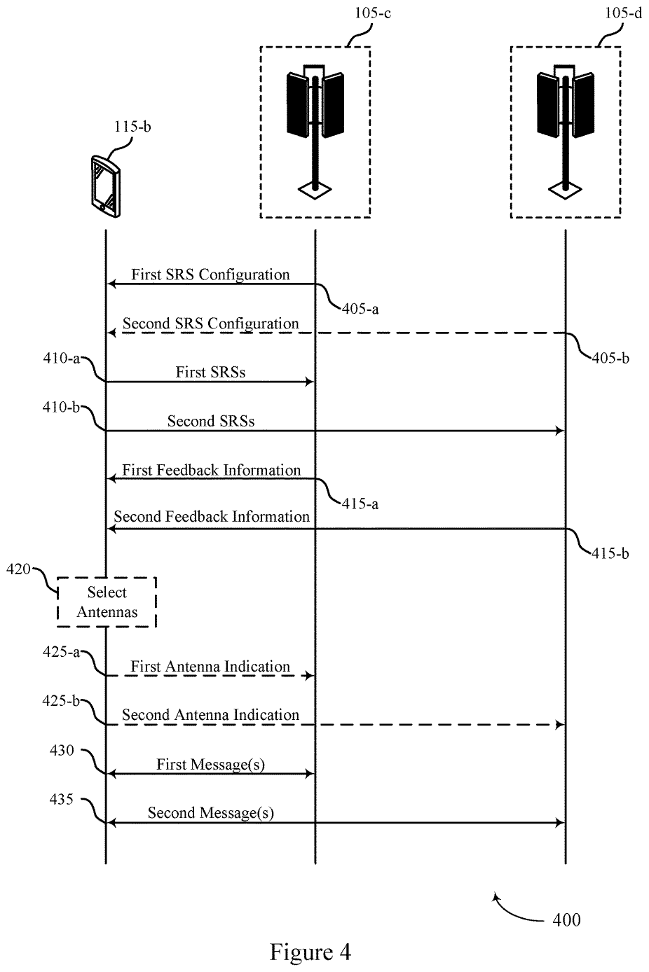

FIG. 4 shows an example of a process flow 400 that supports UE antenna selection based on multi-TRP feedback. In some cases, the process flow 400 may implement or be implemented by aspects of the wireless communication system 100, the signaling diagram 200, the reference signal configurations 300, or any combination thereof. For example, the process flow 400 may be implemented by one or more UEs 115 (e.g., a UE 115-b) and one or more network entities 105 (e.g., a network entity 105-c and a network entity 105-d), which may be examples of the corresponding devices as described herein. In the following description of the process flow 400, the operations may be communicated in a different order than the example order shown, or the operations may be performed in different orders or at different times. Some operations may also be omitted from the process flow 400, and other operations may be added to the process flow 400.

At 405, the UE 115-b may receive configuration information (e.g., one or more SRS configurations) for a set of reference signals, such as SRS, to be measured by a set of multiple network entities 105 (e.g., TRPs), including at least the network entity 105-c and the network entity 105-d.

In some cases (e.g., when reference signals are configured separately), the set of reference signals may include a first subset of reference signals to be measured by the network entity 105-c and a second subset of reference signals to be measured by the network entity 105-d, where the first subset of reference signals is different from the second subset of reference signals. In such cases, to receive the configuration information for the set of reference signals the UE 115-b may, at 405-a, receive, from the network entity 105-c, a first control message indicating first configuration information (e.g., a first SRS configuration) for the first subset of reference signals and, at 405-b, may receive, from the network entity 105-d, a second control message indicating second configuration information (e.g., a second SRS configuration) for the first subset of reference signals.

In some other cases (e.g., when reference signals are configured jointly), the set of reference signals may include a shared set of reference signals to be measured by both the network entity 105-c and the network entity 105-d. In such cases, to receive the configuration information for the set of reference signals, the UE 115-b may receive, from the network entity 105-c, the network entity 105-d or both, common (e.g., shared, coordinated) configuration information for the shared set of reference signals (e.g., the first SRS configuration is the same as the second SRS configuration).

At 410, the UE 115-b may transmit, via multiple antennas of the UE 115-b (e.g., N antennas or K antennas of the N antennas), the set of reference signals in accordance with the configuration information. For example, (e.g., when the reference signals are configured separately), at 410-a, the UE 115-b may transmit, to the network entity 105-c via the multiple antennas, the first subset of reference signals (e.g., first SRSs) and, at 410-b, may transmit, to the network entity 105-d via the multiple antennas, the second subset of reference signals (e.g., second SRS). In such cases, the UE 115-b may transmit each reference signal of the first subset of reference signals via a respective antenna of the plurality of antennas and may transmit each reference signal of the second subset of reference signals via a respective antenna of the plurality of antennas.

In some other examples (e.g., when the reference signals are configured jointly), the UE 115-b may transmit, to the network entity 105-c and the network entity 105-d via the multiple antennas, the shared set of reference signals (e.g., the first SRS are the same as the second SRS). In such cases, each reference signal of the shared set of reference signals may be transmitted via a respective antenna of the plurality of antennas. In some cases, the multiple antennas of the UE 115-b (e.g., K antennas) may be a subset of a total quantity of antennas (e.g., N antennas) of the UE 115-b,

At 415, the UE 115-b may receive, from each of the network entity 105-c and the network entity 105-d, feedback information for the multiple antennas. For example, at 415-a, the UE 115-b may receive, from the network entity 105-c, first feedback information for the multiple antennas (e.g., based on the first subset of reference signals or the shared set of reference signals) and, at 415-b, may receive, from the network entity 105-d, second feedback information for the multiple antennas (e.g., based on the second subset of reference signals or the shared set of reference signals). The feedback information may include (e.g., for each antenna of the multiple antennas) one or more CQIs, one or more MCSs, one or more SNRs, one or more uplink signal strength estimates, one or more uplink channel vector estimates, or any combination thereof.

At 420, the UE 115-b may select a respective subset of the multiple antennas for each network entity 105 based on the feedback information. For example, the UE 115-b may select, for the network entity 105-c, a first subset of antennas (e.g., K₁ antennas) of the multiple antennas (e.g., N antennas or K antennas of the N antennas) based on the first feedback information (e.g., and optionally the second feedback information) and may select, for the network entity 105-d, a second subset of antennas (e.g., K₂ antennas) of the multiple antennas based on the second feedback information (e.g., and optionally the first feedback information).

At 425, the UE 115-b may transmit an antenna selection indication to each network entity 105 indicating a respective antenna selection by the UE 115-b. For example, at 425-a, the UE 115-b may transmit, to the network entity 105-c, a first antenna selection indication indicating the first subset of antennas based on selection of the first subset of antennas for the network entity 105-c. Similarly, at 425-b, the UE 115-b may transmit, to the network entity 105-d, a second antenna selection indication indicating the second subset of antennas based on selection of the second subset of antennas for the network entity 105-d.

At 430, the UE 115-b may communicate one or more first messages with the network entity 105-c via the first subset of antennas (e.g., of the multiple antennas) based on the first subset of antennas being selected for the network entity 105-c.

Similarly, at 435, the UE 115-b may communicate one or more second messages with the network entity 105-d via the second subset of antennas (e.g., of the multiple antennas) based on the second subset of antennas being selected for the network entity 105-d.

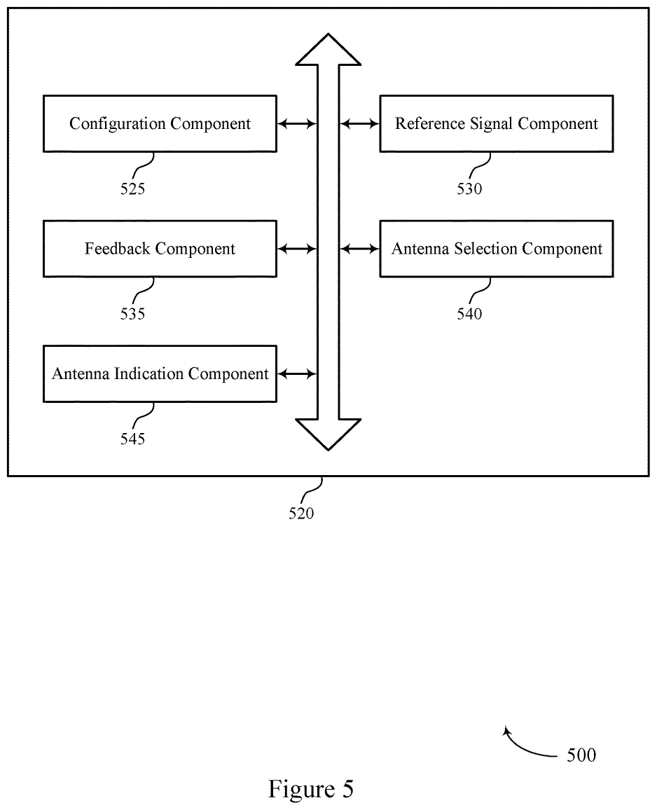

FIG. 5 shows an example 500 of a processing system 520 that supports UE antenna selection based on multi-TRP feedback. A processing system 520 may be an example of a processing system 140 (such as of a UE 115) and may include a configuration component 525, a reference signal component 530, a feedback component 535, an antenna selection component 540, an antenna indication component 545, or any combination thereof. A processing system 520, or various component thereof, may be an example of means for performing (such as a means for causing a UE 115 to perform) various techniques described herein.

The configuration component 525 may be configured to cause the UE 115 to receive configuration information for a set of reference signals to be measured by a set of multiple network entities, the set of multiple network entities including at least a first network entity and a second network entity. The reference signal component 530 may be configured to cause the UE 115 to transmit, via a set of multiple antennas of the UE, the set of reference signals in accordance with the configuration information. The feedback component 535 may be configured to cause the UE 115 to receive, from each of the first network entity and the second network entity, feedback information for the set of multiple antennas. The antenna selection component 540 may be configured to cause the UE 115 to communicate one or more first messages with the first network entity via a first subset of antennas of the set of multiple antennas, where the first subset of antennas is selected based on the feedback information. In some examples, the antenna selection component 540 may be configured to cause the UE 115 to communicate one or more second messages with the second network entity via a second subset of antennas of the set of multiple antennas, where the second subset of antennas is selected based on the feedback information.

In some examples, the set of reference signals include a first subset of reference signals to be measured by the first network entity and a second subset of reference signals to be measured by the second network entity, wherein the first subset of reference signals is different from the second subset of reference signals.

In some examples, to support receiving configuration information for the set of reference signals, the configuration component 525 may be configured to cause the UE 115 to receive, from the first network entity, a first control message indicating first configuration information for the first subset of reference signals. In some examples, to support receiving configuration information for the set of reference signals, the configuration component 525 may be configured to cause the UE 115 to receive, from the second network entity, a second control message indicating second configuration information for the second subset of reference signals.

In some examples, to support transmitting the set of reference signals, the reference signal component 530 may be configured to cause the UE 115 to transmit the first subset of reference signals via the set of multiple antennas of the UE. In some examples, to support transmitting the set of reference signals, the reference signal component 530 may be configured to cause the UE 115 to transmit the second subset of reference signals via the set of multiple antennas of the UE.

In some examples, to support transmitting the set of reference signals, the reference signal component 530 may be configured to cause the UE 115 to transmit each reference signal of the first subset of reference signals via a respective antenna of the set of multiple antennas. In some examples, to support transmitting the set of reference signals, the reference signal component 530 may be configured to cause the UE 115 to transmit each reference signal of the second subset of reference signals via a respective antenna of the set of multiple antennas.

In some examples, the set of reference signals include a shared set of reference signals to be measured by each network entity of the set of multiple network entities.

In some examples, the configuration information is received from one network entity of the set of multiple network entities based on the shared set of reference signals being measured by each network entity of the set of multiple network entities.

In some examples, each reference signal of the shared set of reference signals is transmitted via a respective antenna of the set of multiple antennas.

In some examples, the feedback information includes one or more CQIs, one or more MCSs, one or more uplink SNRs, one or more uplink signal strength estimates, one or more uplink channel vector estimates, or any combination thereof.

In some examples, to support receiving the feedback information, the feedback component 535 may be configured to cause the UE 115 to receive, from the first network entity, first feedback information for the set of multiple antennas. In some examples, to support receiving the feedback information, the feedback component 535 may be configured to cause the UE 115 to receive, from the second network entity, second feedback information for the set of multiple antennas.

In some examples, the antenna selection component 540 may be configured to cause the UE 115 to select, for the first network entity, the first subset of antennas of the set of multiple antennas based on the first feedback information. In some examples, the antenna selection component 540 may be configured to cause the UE 115 to select, for the second network entity of the set of multiple network entities, the second subset of antennas of the set of multiple antennas based on the second feedback information, where the first subset of antennas is different from the second subset of antennas.

In some examples, the antenna indication component 545 may be configured to cause the UE 115 to transmit, to the first network entity, an indication of the first subset of antennas based on selection of the first subset of antennas for the first network entity, where communication of the one or more first messages is based on transmission of the indication.

In some examples, the set of reference signals include a set of SRSs.

In some examples, the set of multiple antennas is a subset of a total quantity of antennas of the UE.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques to enable a UE to perform antenna selection for multiple TRPs based on feedback information received from each of the multiple TRPs, which may result in improved communication reliability, reduced latency, improved user experience related to reduced processing, reduced power consumption, more efficient utilization of communication resources, improved coordination between devices, longer battery life, and improved utilization of processing capability, among other advantages.

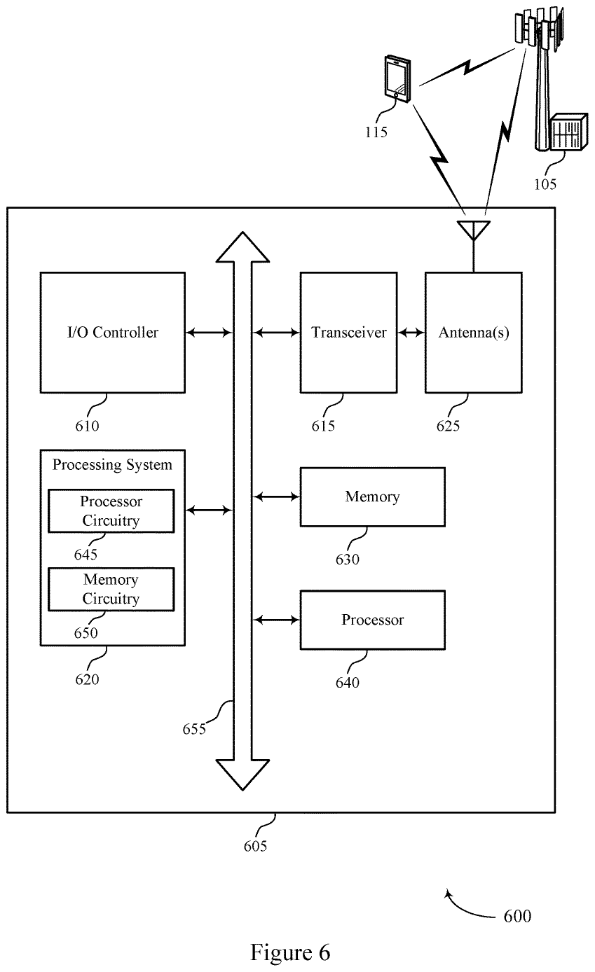

FIG. 6 shows an example of a system 600 including a device 605 that supports UE antenna selection based on multi-TRP feedback. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support UE antenna selection based on multi-TRP feedback. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques to enable a UE to perform antenna selection for multiple TRPs based on feedback information received from each of the multiple TRPs, which may result in improved communication reliability, reduced latency, improved user experience related to reduced processing, reduced power consumption, more efficient utilization of communication resources, improved coordination between devices, longer battery life, and improved utilization of processing capability, among other advantages.

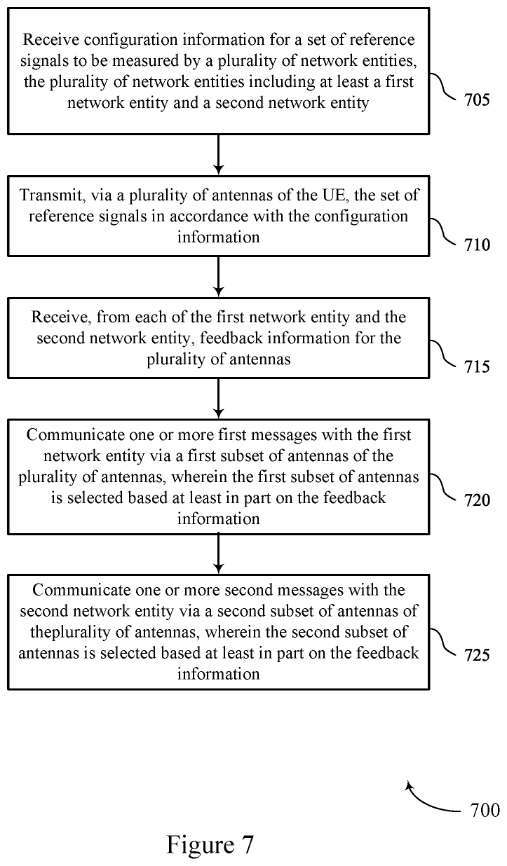

FIG. 7 shows an example of a method 700 that supports UE antenna selection based on multi-TRP feedback. Operations of the method 700 may be performed by a UE or its components (such as using a processing system configured to cause the UE 115 to perform one or more of the operations) as described herein.

At 705, the method may include receiving configuration information for a set of reference signals to be measured by a plurality of network entities, the plurality of network entities including at least a first network entity and a second network entity. In some examples, aspects of the operations of 705 may be performed by a configuration component 525.

At 710, the method may include transmitting, via a plurality of antennas of the UE, the set of reference signals in accordance with the configuration information. In some examples, aspects of the operations of 710 may be performed by a reference signal component 530.

At 715, the method may include receiving, from each of the first network entity and the second network entity, feedback information for the plurality of antennas. In some examples, aspects of the operations of 715 may be performed by a feedback component 535.

At 720, the method may include communicating one or more first messages with the first network entity via a first subset of antennas of the plurality of antennas, wherein the first subset of antennas is selected based at least in part on the feedback information. In some examples, aspects of the operations of 720 may be performed by an antenna selection component 540.

At 725, the method may include communicating one or more second messages with the second network entity via a second subset of antennas of the plurality of antennas, wherein the second subset of antennas is selected based at least in part on the feedback information. In some examples, aspects of the operations of 725 may be performed by an antenna selection component 540.

Implementation examples are described in the following numbered clauses:

Aspect 1: A method for wireless communications at a UE, comprising: receiving configuration information for a set of reference signals to be measured by a plurality of network entities, the plurality of network entities comprising at least a first network entity and a second network entity; transmitting, via a plurality of antennas of the UE, the set of reference signals in accordance with the configuration information; receiving, from each of the first network entity and the second network entity, feedback information for the plurality of antennas; communicating one or more first messages with the first network entity via a first subset of antennas of the plurality of antennas, wherein the first subset of antennas is selected based at least in part on the feedback information; and communicating one or more second messages with the second network entity via a second subset of antennas of the plurality of antennas, wherein the second subset of antennas is selected based at least in part on the feedback information.

Aspect 2: The method of aspect 1, wherein the set of reference signals comprise a first subset of reference signals to be measured by the first network entity and a second subset of reference signals to be measured by the second network entity, wherein the first subset of reference signals is different from the second subset of reference signals.

Aspect 3: The method of aspect 2, wherein receiving configuration information for the set of reference signals comprises: receiving, from the first network entity, a first control message indicating first configuration information for the first subset of reference signals; and receiving, from the second network entity, a second control message indicating second configuration information for the second subset of reference signals.

Aspect 4: The method of any of aspects 2 through 3, wherein transmitting the set of reference signals further comprises: transmitting the first subset of reference signals via the plurality of antennas of the UE; and transmitting the second subset of reference signals via the plurality of antennas of the UE.

Aspect 5: The method of aspect 4, wherein transmitting the set of reference signals further comprises: transmitting each reference signal of the first subset of reference signals via a respective antenna of the plurality of antennas, and transmitting each reference signal of the second subset of reference signals via a respective antenna of the plurality of antennas.

Aspect 6: The method of any of aspects 1 through 5, wherein the set of reference signals comprise a shared set of reference signals to be measured by each network entity of the plurality of network entities.

Aspect 7: The method of aspect 6, wherein the configuration information is received from one network entity of the plurality of network entities based at least in part on the shared set of reference signals being measured by each network entity of the plurality of network entities.

Aspect 8: The method of any of aspects 6 through 7, wherein each reference signal of the shared set of reference signals is transmitted via a respective antenna of the plurality of antennas.

Aspect 9: The method of any of aspects 1 through 8, wherein the feedback information comprises one or more CQIs, one or more MCSs, one or more uplink SNRs, one or more uplink signal strength estimates, one or more uplink channel vector estimates, or any combination thereof.

Aspect 10: The method of any of aspects 1 through 9, wherein receiving the feedback information comprises: receiving, from the first network entity, first feedback information for the plurality of antennas; and receiving, from the second network entity, second feedback information for the plurality of antennas.

Aspect 11: The method of aspect 10, further comprising: selecting, for the first network entity, the first subset of antennas of the plurality of antennas based at least in part on the first feedback information; and selecting, for the second network entity of the plurality of network entities, the second subset of antennas of the plurality of antennas based at least in part on the second feedback information, wherein the first subset of antennas is different from the second subset of antennas.

Aspect 12: The method of any of aspects 1 through 11, further comprising: transmitting, to the first network entity, an indication of the first subset of antennas based at least in part on selection of the first subset of antennas for the first network entity, wherein communication of the one or more first messages is based at least in part on transmission of the indication.

Aspect 13: The method of any of aspects 1 through 12, wherein the set of reference signals comprise a set of SRSs.

Aspect 14: The method of any of aspects 1 through 13, wherein the plurality of antennas is a subset of a total quantity of antennas of the UE.

Aspect 15: A UE for wireless communications, comprising a processing system that includes processor circuitry and memory circuitry that stores code, the processing system configured to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information for a set of reference signals to be measured by a plurality of network entities, the plurality of network entities comprising at least a first network entity and a second network entity;
transmit, via a plurality of antennas of the UE, the set of reference signals in accordance with the configuration information;
receive, from each of the first network entity and the second network entity, feedback information for the plurality of antennas;
communicate one or more first messages with the first network entity via a first subset of antennas of the plurality of antennas, wherein the first subset of antennas is selected based at least in part on the feedback information; and
communicate one or more second messages with the second network entity via a second subset of antennas of the plurality of antennas, wherein the second subset of antennas is selected based at least in part on the feedback information.

2. The UE of claim 1, wherein the set of reference signals comprise a first subset of reference signals to be measured by the first network entity and a second subset of reference signals to be measured by the second network entity, wherein the first subset of reference signals is different from the second subset of reference signals.

3. The UE of claim 2, wherein, to receive configuration information for the set of reference signals, the one or more processors are individually or collectively operable to execute the code to cause the UE to:
receive, from the first network entity, a first control message indicating first configuration information for the first subset of reference signals; and
receive, from the second network entity, a second control message indicating second configuration information for the second subset of reference signals.

4. The UE of claim 2, wherein, to transmit the set of reference signals, the one or more processors are individually or collectively further operable to execute the code to cause the UE to:
transmit the first subset of reference signals via the plurality of antennas of the UE; and
transmit the second subset of reference signals via the plurality of antennas of the UE.

5. The UE of claim 4, wherein, to transmit the set of reference signals, the one or more processors are individually or collectively further operable to execute the code to cause the UE to:
transmit each reference signal of the first subset of reference signals via a respective antenna of the plurality of antennas, and
transmit each reference signal of the second subset of reference signals via a respective antenna of the plurality of antennas.

6. The UE of claim 1, wherein the set of reference signals comprise a shared set of reference signals to be measured by each network entity of the plurality of network entities.

7. The UE of claim 6, wherein the configuration information is received from one network entity of the plurality of network entities based at least in part on the shared set of reference signals being measured by each network entity of the plurality of network entities.

8. The UE of claim 6, wherein each reference signal of the shared set of reference signals is transmitted via a respective antenna of the plurality of antennas.

9. The UE of claim 1, wherein the feedback information comprises one or more channel quality indicators (CQIs), one or more modulation and coding schemes (MCSs), one or more uplink signal-to-noise ratios (SNRs), one or more uplink signal strength estimates, one or more uplink channel vector estimates, or any combination thereof.

10. The UE of claim 1, wherein, to receive the feedback information, the one or more processors are individually or collectively operable to execute the code to cause the UE to:
receive, from the first network entity, first feedback information for the plurality of antennas; and
receive, from the second network entity, second feedback information for the plurality of antennas.

11. The UE of claim 10, wherein the one or more processors are individually or collectively further operable to execute the code to cause the UE to:
select, for the first network entity, the first subset of antennas of the plurality of antennas based at least in part on the first feedback information; and
select, for the second network entity of the plurality of network entities, the second subset of antennas of the plurality of antennas based at least in part on the second feedback information, wherein the first subset of antennas is different from the second subset of antennas.

12. The UE of claim 1, wherein the one or more processors are individually or collectively further operable to execute the code to cause the UE to:
transmit, to the first network entity, an indication of the first subset of antennas based at least in part on selection of the first subset of antennas for the first network entity, wherein communication of the one or more first messages is based at least in part on transmission of the indication.

13. The UE of claim 1, wherein the set of reference signals comprise a set of sounding reference signals (SRSs).

14. The UE of claim 1, wherein the plurality of antennas is a subset of a total quantity of antennas of the UE.

15. A method for wireless communications at a user equipment (UE), comprising:
receiving configuration information for a set of reference signals to be measured by a plurality of network entities, the plurality of network entities comprising at least a first network entity and a second network entity;
transmitting, via a plurality of antennas of the UE, the set of reference signals in accordance with the configuration information;
receiving, from each of the first network entity and the second network entity, feedback information for the plurality of antennas;
communicating one or more first messages with the first network entity via a first subset of antennas of the plurality of antennas, wherein the first subset of antennas is selected based at least in part on the feedback information; and
communicating one or more second messages with the second network entity via a second subset of antennas of the plurality of antennas, wherein the second subset of antennas is selected based at least in part on the feedback information.

16. The method of claim 15, wherein the set of reference signals comprise a first subset of reference signals to be measured by the first network entity and a second subset of reference signals to be measured by the second network entity, wherein the first subset of reference signals is different from the second subset of reference signals.

17. The method of claim 15, wherein the set of reference signals comprise a shared set of reference signals to be measured by each network entity of the plurality of network entities.

18. The method of claim 15, wherein the feedback information comprises one or more channel quality indicators (CQIs), one or more modulation and coding schemes (MCSs), one or more uplink signal-to-noise ratios (SNRs), one or more uplink signal strength estimates, one or more uplink channel vector estimates, or any combination thereof.

19. The method of claim 15, further comprising:
transmitting, to the first network entity, an indication of the first subset of antennas based at least in part on selection of the first subset of antennas for the first network entity, wherein communication of the one or more first messages is based at least in part on transmission of the indication.

20. A non-transitory computer-readable medium storing code for wireless communications, the code comprising instructions executable by one or more processors to:
receive configuration information for a set of reference signals to be measured by a plurality of network entities, the plurality of network entities comprising at least a first network entity and a second network entity;
transmit, via a plurality of antennas of the UE, the set of reference signals in accordance with the configuration information;
receive, from each of the first network entity and the second network entity, feedback information for the plurality of antennas;
communicate one or more first messages with the first network entity via a first subset of antennas of the plurality of antennas, wherein the first subset of antennas is selected based at least in part on the feedback information; and
communicate one or more second messages with the second network entity via a second subset of antennas of the plurality of antennas, wherein the second subset of antennas is selected based at least in part on the feedback information.
